(19) United States
(12) Patent Application Publication
(10) Pub. No.: US 2018/0340059 A1
(43) Pub. Date: Nov. 29, 2018

(54) Compositions and Heavy Layers Comprising the Same

(71) Applicant: ExxonMobil Chemical Patents Inc., Baytown, TX (US)

(72) Inventors: Saifudin M. Abubakar, Shanghai (CN); Wei Hu, Shanghai (CN); Yiyuan Zhang, Shanghai (CN); Jia Jun Chen, Guangzhou (CN)

(21) Appl. No.: 15/949,507

(22) Filed: Apr. 10, 2018

Related U.S. Application Data
(60) Provisional application No. 62/511,520, filed on May 26, 2017.

(51) Int. Cl. C08L 23/14; C08L 23/08; C08J 9/36; B32B 5/18; B32B 27/06; B32B 27/32

(52) U.S. Cl. CPC C08L 23/14; B32B 2605/003; C08J 9/365; B32B 5/18; B32B 27/065; B32B 27/32; C08L 2205/03; C08L 2205/025; C08J 2375/04; C08J 2423/08; C08J 2423/14; C08L 2207/066; B32B 2250/02; B32B 2250/24; B32B 2266/0278; B32B 2323/046; B32B 2323/10; C08L 23/08

(57) ABSTRACT

Disclosed herein are compositions comprising a propylene-based elastomer, an ethylene-based polymer, a filler, and a polar component. The polar polymer can comprise one or more of a tackifier, a grafted propylene-based elastomer, and an ethylene copolymer having polar comonomers, as well as a composite material comprising a first layer made from such composition and a second layer that can be made from polar material and is well bonded onto the first layer.

### PRIORITY CLAIM

This application claims the benefit of Provisional Application No. 62/511,520, filed May 26, 2017, the disclosures of which is incorporated herein by reference.

### FIELD OF THE INVENTION

The present invention relates to compositions comprising propylene-based polymers and heavy layers comprising the same suitable for automobile industries.

### BACKGROUND OF THE INVENTION

Filled heavy layers are commonly used in making carpets and automobile parts such as dashboard illustrators, front wall mats, floor mats etc. ExxonMobil's propylene-based elastomers like those sold under the trade name Vistamaxx™ are found useful for these applications due to its high filler loading ability, for example in carpet backing as disclosed in U.S. Patent Application Publications No. 20150176201 and No. 2016102429.

When the filled heavy layers are used in automobile parts like front walls, usually a second layer such as a polyurethane (PU) foam layer is bonded onto the heavy layers to provide desired properties, such as sound and vibration absorption. As the second layer can be made of a polar material, e.g., PU, and the propylene-based polymers have relatively weak polarity, delamination may result after a thermoforming process.

There is a need to improve the bonding strength between the heavy layer and the polar second layer. Attempts such as treatment with corona to the heavy layer failed to improve the bonding strength. Other attempts like use of other polyolefin elastomers and/or styrene-ethylene/butylene-styrene (SEBS) rubbers are reportedly unable to effectively solve this issue.

Therefore there is a continuous need to improve the bonding strength between filled heavy layer and polar layers bonded thereto while maintaining good mechanical and physical properties such as softness and elongation.

### SUMMARY OF THE INVENTION

This invention fulfills the need for compositions comprising propylene-based elastomers having improved bonding strength with other polar layers while maintaining or improving other desired properties.

The present invention relates to compositions comprising, based on the weight of the composition: (i) from about 3 wt. % to about 25 wt. %, or from about 10 wt. % to about 20 wt. % of a first component comprising a propylene-based elastomer, the propylene-based elastomer comprises at least about 75 wt. %, or from about 80 wt. % to about 97 wt. % of propylene-derived units and less than 25 wt. %, or from about 3 wt. % to about 20 wt. % of units derived from at least one of ethylene and C₄-C₂₀ alpha-olefins, based on the weight of the propylene-based elastomer, and has an mm propylene triad tacticity of greater than 75%, and a heat of fusion of less than 75 J/g; (ii) from about 1 wt. % to about 25 wt. %, or from about 5 wt. % to about 15 wt. % of a second component comprising an ethylene-based polymer, the ethylene-based polymer comprises at least 80 wt. % of ethylene-derived units and less than about 20 wt. % of units derived from C₃-C₁₂ alpha olefins, and has a density of less than about 0.940 g/cm³ and a melt index at 190° C./2.16 kg (I_{2.16}) of from about 0.1 to about 40 g/10 min; (iii) from about 0.5 wt. % to about 15 wt. %, or from about 2 wt. % to about 10 wt. % of a third component having polarity; and (iv) from about 50 wt. % to about 90 wt. %, or from about 60 wt. % to about 80 wt. % of a filler.

In some embodiments, the third component is selected from the group consisting of a tackifier, a grafted polyolefin-based polymer, and an ethylene copolymer comprising polar comonomers. The ethylene copolymer can comprise polar comonomers(s) selected from vinyl acetate, methyl acetate, butyl acetate, and acrylic acid in an amount of from about 5 wt. % to 30 wt. %. The grafted polyolefin-based polymer can comprise a grafted propylene-based elastomer. The grafted propylene-based elastomer comprising, based on the weight of the grafted propylene-based elastomer can comprise (i) propylene-derived monomer units; (ii) from 5 wt. % to 25 wt. % comonomer units derived from any of C₂ or C₄-C₂₀ alpha olefins; and (iii) from 0.1 wt. % to 10 wt. % graft comonomer units, and have a heat of fusion of less than 75 J/g and an mm propylene triad tacticity of greater than 75%. The tackifier comprises an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof. In some preferred embodiments, the tackifier has a total dicyclopentadiene, cyclopentadiene, and methylcyclopentadiene derived content of from about 60 wt. % to about 100 wt. %. In still preferred embodiments, the tackifier has a weight average molecular weight of from about 600 g/mole to about 1400 g/mole.

The present invention also provides a composite material, comprising a first layer and a second layer bonded onto the first layer, wherein the first layer comprises, based on the weight of the first layer: (i) from 10 wt. % to 20 wt. % of the propylene-based elastomer, the propylene-based elastomer comprising from 5 wt. % to 25 wt. % at least one comonomer selected from ethylene and C₄-C₂₀ alpha-olefins and a propylene content of at least 75 wt. %, and having an mm propylene triad tacticity of at least an 75%, and a heat of fusion of less than 75 J/g; (ii) from 5 wt. % to 15 wt. % of a liner low density polyethylene having a density of less than 0.940 g/cm³ and a melt index at 190° C./2.16 kg (I_{2.16}) of from 0.1 to 30 g/10 min; (iii) from 60 wt. % to 80 wt. % of a filler; and (iv) from 2 wt. % to 10 wt. % of a tackifier having a total dicyclopentadiene, cyclopentadiene, and methylcyclopentadiene derived content of from 60 wt. % to about 100 wt. % of the total weight of the tackifier, and has a weight average molecular weight of from 600 g/mole to 1400 g/mole; and the second layer comprises polyurethane foam.

The present composition has a Shore A hardness of less than about 90, or less than about 85, and/or an elongation at break of at least about 180%, or at least about 200%, or at least about 300% or at least about 400%.

The present invention also relates to a composite material comprising a first layer made from the above inventive composition and a second layer bonded onto the first layer.

### BRIEF DESCRIPTION OF DRAWINGS

FIG. 1 illustrates a process for thermoforming the composite material according to the present invention.

FIG. 2 shows the delamination result of the composite material comprising PU foam layer and the heavy layer made from the compositions of illustrated examples 1 to 5.

### DETAILED DESCRIPTION

The present invention provides compositions and composite material comprising such compositions. The inventive compositions comprise a first component comprising propylene-based elastomer, a second component comprising an ethylene copolymer of C₃-C₁₂ comonomer(s), a third component having polarity, and a fourth component comprising filler(s). Now each component and the composite material will be described below in detail.

Without wishing to be bound by theory, it is believed that addition of the selected third component improves the polarity of the composition and accordingly the bonding strength with other layers, in particular a layer exhibiting certain polarity, such as a PU foam layer.

### Definitions

The term “polymer” as used herein includes, but is not limited to, homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations may include isotactic, syndiotactic, and random symmetries.

As used herein, unless specified otherwise, the term “copolymer(s)” refers to polymers formed by the polymerization of at least two different monomers. For example, the term “copolymer” includes the copolymerization reaction product of propylene and an alpha-olefin, such as ethylene, 1-hexene. However, the term “copolymer” is also inclusive of, for example, the copolymerization of a mixture of ethylene, propylene, 1-hexene, and 1-octene.

As used herein, when a polymer is referred to as “comprising a monomer,” the monomer is present in the polymer in the polymerized form of the monomer or in the derivative form of the monomer.

The term “elastomer”, as used herein, refers to any polymer or composition of polymers consistent with the ASTM D1566 definition.

Weight-average molecular weight, M_{w}, molecular weight distribution (MWD) or M_{w}/Mₙ where Mₙ is the number-average molecular weight, and the branching index, g′(vis), are characterized using a High Temperature Size Exclusion Chromatograph (SEC), equipped with a differential refractive index detector (DRI), an online light scattering detector (LS), and a viscometer. Experimental details not shown below, including how the detectors are calibrated (with polystyrene standard), are described in: T. Sun, P. Brant, R. R. Chance, and W. W. Graessley, Macromolecules, Volume 34, Number 19, pp. 6812-6820, 2001.

Solvent for the SEC experiment is prepared by dissolving 6 g of butylated hydroxy toluene as an antioxidant in 4 L of Aldrich reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for about 2 hours. All quantities are measured gravimetrically. The TCB densities used to express the polymer concentration in mass/volume units are 1.463 g/mL at room temperature and 1.324 g/mL at 135° C. The injection concentration ranges from 1.0 to 2.0 mg/mL, with lower concentrations being used for higher molecular weight samples. Prior to running each sample, the DRI detector and the injector are purged. Flow rate in the apparatus is then increased to 0.5 mL/min, and the DRI was allowed to stabilize for 8-9 hours before injecting the first sample. The LS laser is turned on 1 to 1.5 hours before running samples. As used herein, the term “room temperature” is used to refer to the temperature range of about 20° C. to about 23.5° C.

The concentration, c, at each point in the chromatogram is calculated from the baseline-subtracted DRI signal, I_{DRI}, using the following equation:

c=K_{DRI}I_{DRI}/(dₙ/d_{c})

where K_{DRI} is a constant determined by calibrating the DRI, and dn/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, Light Scattering from Polymer Solutions, Academic Press, 1971):

[K_{O}c/ΔR(θ,c)]=[1/MP(θ)]+2A₂c′,

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and K_{O} is the optical constant for the system:

$${K}_{o} = \frac{4 {π}^{2} {{n}^{2} ( dn / dc )}^{2}}{{λ}^{4} {N}_{A}} ,$$

in which N_{A} is the Avogadro's number, and dn/dc is the refractive index increment for the system. The refractive index, n=1.500 for TCB at 135° C. and λ=690 nm. In addition, A₂=0.0015 and dn/dc=0.104 for ethylene polymers, whereas A₂=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

M_{w}≡ΣwᵢMᵢ=(ΣNᵢMᵢ²/ΣNᵢMᵢ),

since the weight fraction wᵢ is defined as the weight of molecules of molecular weight Mᵢ divided by the total weight of all the molecules present:

wᵢ=NᵢMᵢ/ΣNᵢMᵢ

The number-average molecular weight, Mₙ, is defined as the sum of the products of the molecular weight Mᵢ of each fraction multiplied by its mole fraction xᵢ:

Mₙ≡ΣxᵢMᵢ=ΣNᵢMᵢ/ΣNᵢ,

since the mole fraction xᵢ is defined as Nᵢ divided by the total number of molecules:

xᵢ=Nᵢ/ΣNᵢ

In the SEC, a high temperature Viscotek Corporation viscometer is used, which has four capillaries arranged in a Wheatstone bridge configuration with two pressure transducers. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²

where c was determined from the DRI output.

The branching index (g′, also referred to as g′(vis)) is calculated using the output of the SEC-DRI-LS-VIS method as follows. The average intrinsic viscosity, [η]_{avg}, of the sample is calculated by:

$${[ η ]}_{avg} = \frac{Σ {{c}_{i} [ η ]}_{i}}{Σ {c}_{i}} ,$$

where the summations are over the chromatographic slices, i, between the integration limits.

The branching index g′ is defined as:

$${g}^{′} = \frac{{[ η ]}_{avg}}{{kM}_{v}^{α}} ,$$

where k=0.000579 and α=0.695 for ethylene polymers; k=0.0002288 and α=0.705 for propylene polymers; and k=0.00018 and α=0.7 for butene polymers.

M_{V} is the viscosity-average molecular weight based on molecular weights determined by the LS analysis:

M_{V}≡(ΣcᵢMᵢ^{α}/Σcᵢ/^{1/α}.

For purposes of the invention, unless otherwise specified, heat of fusion and melting point (T_{M}) values are determined by differential scanning calorimetry (DSC) in accordance with the following procedure. From about 6 mg to about 10 mg of a sheet of the polymer pressed at approximately 200° C. to 230° C. is removed with a punch die. This is annealed at room temperature for at least 2 weeks. As used herein, the term “room temperature” is used to refer to the temperature range of about 20° C. to about 23.5° C. At the end of this period, the sample is placed in a Differential Scanning calorimeter (TA Instruments Model 2920 DSC) and cooled to about −50° C. to about −70° C. at a cooling rate of about 10° C./min. The sample is heated at 10° C./min to attain a final temperature of about 200° C. to about 220° C. The thermal output is recorded as the area under the melting peak of the sample which is typically peaked at about 30° C. to about 175° C. and occurs between the temperatures of about 0° C. and about 200° C. is a measure of the heat of fusion expressed in Joules per gram of polymer. The melting point is recorded as the temperature of the greatest heat absorption within the range of melting of the sample.

When referred to herein, a component or polymer's “polarity” and being “polar”, it means the molecules or chemical groups of polymer can separate electric charge resulting dipole or multipole moment. In some embodiments, the polymer comprises polar groups present in an amount of more than about 0.1 wt. %, preferably more than about 0.5 wt. %, more than about 1.0 wt. %.

### Propylene-Based Elastomer

The inventive compositions comprise a first component that comprises at least one propylene-based elastomer. As used herein, the term “propylene-based elastomer” means a polymer comprising at least about 75 wt. % of units derived from propylene and less than about 25 wt. % of units derived from ethylene, a C₄ to C₂₀ alpha-olefin comonomer, or mixtures thereof, based upon total weight of the propylene-based elastomer.

Particularly suitable propylene-based elastomers include copolymers of propylene and at least one comonomer selected from ethylene and C₄-C₁₀ alpha-olefins. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

Preferably, the propylene content of the propylene-based elastomer may range from an upper limit of about 97 wt. %, about 95 wt. %, about 94 wt. %, about 92 wt. %, about 90 wt. %, or about 85 wt. %, to a lower limit of about 75 wt. %, about 80 wt. %, about 82 wt. %, about 85 wt. %, or about 90 wt. %, for example, from about 75 wt. % to about 99 wt. %, from about 80 wt. % to about 99 wt. %, or from about 90 wt. % to about 97 wt. %, based on the weight of the propylene-based elastomer. Preferably, the comonomer content of the propylene-based elastomer may range from about 3 wt. % to about 25 wt. %, or about 3 wt. % to about 20 wt. %, or about 3 wt. % to about 18 wt. %, or from about 3 wt. % to about 11 wt. %, of the propylene-based elastomer. The comonomer content may be adjusted so that the propylene-based elastomer has a heat of fusion of less than about 75 J/g, a melting point of about 115° C. or less, and a crystallinity of about 2% to about 65% of the crystallinity of isotactic polypropylene, and a fractional melt mass-flow rate (230° C., 2.16 kg) of about 0.5 to about 20 g/10 min.

Preferably, the comonomer is ethylene, 1-hexene, or 1-octene, with ethylene being most preferred. Where the propylene-based elastomer comprises ethylene-derived units, the propylene-based elastomer may comprise an ethylene content from about 3 wt. % to about 25 wt. %, or about 4 wt. % to about 20 wt. %, or about 9 wt. % to about 18 wt. %. Often, the propylene-based elastomer consists essentially of units derived from propylene and ethylene, i.e., the propylene-based elastomer does not contain any other comonomer in an amount other than that typically present as impurities in the ethylene and/or propylene feedstreams used during polymerization, or in an amount that would materially affect the heat of fusion, melting point, crystallinity, or fractional melt mass-flow rate of the propylene-based elastomer, or in an amount such that any other comonomer is intentionally added to the polymerization process.

Often, the propylene-based elastomer may comprise more than one comonomer. Preferred propylene-based elastomers having more than one comonomer include propylene-ethylene-octene, propylene-ethylene-hexene, and propylene-ethylene-butene polymers. Where more than one comonomer is present, a single comonomer may be present at a concentration of less than about 5 wt. % of the propylene-based elastomer, but the total comonomer content of the propylene-based elastomer is generally about 5 wt. % or greater.

The propylene-based elastomer may have an mm triad tacticity index as measured by ¹³C NMR, of at least about 75%, at least about 80%, at least about 82%, at least about 85%, or at least about 90%. Preferably, the propylene-based elastomer has an mm triad tacticity of about 75% to about 99%, or about 80% to about 99%. In some embodiments, the propylene-based elastomer may have an mm triad tacticity of about 75% to 97%. The “mm triad tacticity index” of a polymer is a measure of the relative isotacticity of a sequence of three adjacent propylene units connected in a head-to-tail configuration. More specifically, in the present invention, the mm triad tacticity index (also referred to as the “mm Fraction”) of a polypropylene homopolymer or copolymer is expressed as the ratio of the number of units of meso tacticity to all of the propylene triads in the copolymer:

$$mmFraction = \frac{PPP ( mm )}{PPP ( mm ) + PPP ( mr ) + PPP ( rr )} ,$$

where PPP(mm), PPP(mr) and PPP(rr) denote peak areas derived from the methyl groups of the second units in the possible triad configurations for three head-to-tail propylene units, shown below in Fischer projection diagrams:

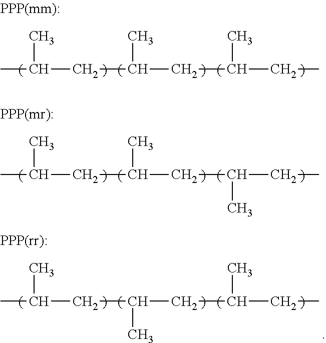

The calculation of the mm Fraction of a propylene polymer is described in U.S. Pat. No. 5,504,172 (homopolymer: column 25, line 49 to column 27, line 26; copolymer: column 28, line 38 to column 29, line 67). For further information on how the mm triad tacticity can be determined from a ¹³C-NMR spectrum, see 1) J. A. Ewen, CATALYTIC POLYMERIZATION OF OLEFINS: PROCEEDINGS OF THE INTERNATIONAL SYMPOSIUM ON FUTURE ASPECTS OF OLEFIN P_{OLYMERIZATION}, T. Keii and K. Soga, Eds. (Elsevier, 1986), pp. 271-292; and 2) U.S. Patent Application US2004/054086 (paragraphs [0043] to [0054]).

The propylene-based elastomer generally has a heat of fusion of less than about 75 J/g, or about 65 J/g or less, or about 60 J/g or less, or about 50 J/g or less, or about 40 J/g or less. The propylene-based elastomer may have a lower limit H_{f} of about 0.5 J/g, or about 1 J/g, or about 5 J/g. For example, the H_{f} value may range from a lower limit of about 1.0, 1.5, 3.0, 4.0, 6.0, or 7.0 J/g, to an upper limit of about 35, 40, 50, 60, or 65 J/g.

The propylene-based elastomer may have a percent crystallinity, as determined according to ASTM D3418-03 with a 10° C./min heating/cooling rate, of about 2% to about 65%, or about 0.5% to about 40%, or about 1% to about 30%, or about 5% to about 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of about 0.25% to about 25%, or in the range of about 0.5% to about 22%, of the crystallinity of isotactic polypropylene.

In any embodiment, the propylene-based elastomer may have a tacticity index [m/r] from a lower limit of about 4, or about 6, to an upper limit of about 8, or about 10, or about 12. Often, the propylene-based elastomer has an isotacticity index greater than 0%, or within the range having an upper limit of about 50%, or about 25%, and a lower limit of about 3%, or about 10%. The tacticity index is calculated as defined in H. N. Cheng, Macromolecules, 17, 1950 (1984). When [m/r] is 0 to less than 1.0, the polymer is generally described as syndiotactic, when [m/r] is 1.0 the polymer is atactic, and when [m/r] is greater than 1.0 the polymer is generally described as isotactic.

Often, the propylene-based elastomer may further comprise diene-derived units (as used herein, “diene”). The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkylene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of about 15%, about 10%, about 7%, about 5%, about 4.5%, about 3%, about 2.5%, or about 1.5%, to a lower limit of about 0%, about 0.1%, about 0.2%, about 0.3%, about 0.5%, about 1%, about 3%, or about 5%, based on the total weight of the propylene-based elastomer.

The propylene-based elastomer may have a single peak melting transition as determined by DSC. In some embodiments, the copolymer has a primary peak transition of about 90° C. or less, with a broad end-of-melt transition of about 110° C. or greater. The peak “melting point” (“Tₘ”) is defined as the temperature of the greatest heat absorption within the range of melting of the sample. However, the copolymer may show secondary melting peaks adjacent to the principal peak, and/or at the end-of-melt transition. For the purposes of this disclosure, such secondary melting peaks are considered together as a single melting point, with the highest of these peaks being considered the Tₘ of the propylene-based elastomer. The propylene-based elastomer may have a Tₘ of about 115° C. or less, about 110° C. or less, about 105° C. or less, about 100° C. or less, about 90° C. or less, about 80° C. or less, or about 70° C. or less. In some embodiments, the propylene-based elastomer has a Tₘ of about 25° C. to about 115° C., or about 40° C. to about 110° C., or about 60° C. to about 105° C.

The propylene-based elastomer may have a density of about 0.850 to about 0.900 g/cm³, or about 0.860 to about 0.880 g/cm³, at room temperature as measured based on ASTM D1505.

The propylene-based elastomer may have a fractional melt mass-flow rate (MFR), as measured based on ASTM D1238, 2.16 kg at 230° C., of at least about 0.5 g/10 min. In some embodiments, the propylene-based elastomer may have a fractional MFR of about 0.5 to about 50 g/10 min, or about 2 to about 18 g/10 min. The propylene-based elastomer may have an Elongation at Break of less than about 2000%, less than about 1800%, less than about 1500%, or less than about 1000%, as measured based on ASTM D638.

The propylene-based elastomer may have an Mw of about 5,000 to about 5,000,000 g/mol, or about 10,000 to about 1,000,000 g/mol, or about 50,000 to about 400,000 g/mol. The propylene-based elastomer may have an Mn of about 2,500 to about 250,000 g/mol, or about 10,000 to about 250,000 g/mol, or about 25,000 to about 250,000 g/mol. The propylene-based elastomer may have a an Mz of about 10,000 to about 7,000,000 g/mol, or about 80,000 to about 700,000 g/mol, or about 100,000 to about 500,000 g/mol. The propylene-based elastomer may have an Mw/Mn of about 1.5 to about 20, or about 1.5 to about 15, or about 1.5 to about 5, or about 1.8 to about 3, or about 1.8 to about 2.5.

Suitable propylene-based elastomers may be available commercially under the trade names VISTAMAXX™ (ExxonMobil Chemical Company, Houston, Tex., USA), VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins, Netherlands). The particular grade(s) of commercially available propylene-based elastomer suitable for use in the invention can be readily determined using methods commonly known in the art.

### Ethylene-Based Polymer

The ethylene-based polymers useful in the present application comprises at least 80 wt. % of ethylene-derived units and less than 20 wt. % of units derived from C₃-C₁₂ alpha olefins, and has a density of less than 0.940 g/cm³ and a melt index at 190° C./2.16 kg (I_{2.16}) of from 0.1 to 40 g/10 min Examples of the ethylene-based polymers comprise low density polyethylene and linear low density polyethylene.

The present inventive composition may comprise a linear low density polyethylene (LLDPE) polymer as the second component. As used herein, the terms “linear low density polyethylene” and “LLDPE” refer to a polyethylene homopolymer or, preferably, copolymer having minimal long chain branching and a density of from about 0.910 g/cm³ to about 0.940 g/cm³. Polymers having more than two types of monomers, such as terpolymers, are also included within the term “copolymer” as used herein. In preferred embodiments of the invention, the LLDPE is a copolymer of ethylene and at least one other α-olefin. The comonomers that are useful in general for making LLDPE copolymers include α-olefins, such olefin comonomer may be linear or branched, and two or more comonomers may be used, if desired. Examples of suitable comonomers include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Specifically, but without limitation, the combinations of ethylene with a comonomer may include: ethylene propylene, ethylene butene, ethylene 1-pentene; ethylene 4-methyl-1-pentene; ethylene 1-hexene; ethylene 1-octene; ethylene decene; ethylene dodecene; ethylene 1-hexene 1-pentene; ethylene 1-hexene 4-methyl-1-pentene; ethylene 1-hexene 1-octene; ethylene 1-hexene decene; ethylene 1-hexene dodecene; ethylene 1-octene 1-pentene; ethylene 1-octene 4-methyl-1-pentene; ethylene 1-octene 1-hexene; ethylene 1-octene decene; ethylene 1-octene dodecene; combinations thereof and like permutations.

The LLDPE polymers of the present invention may be obtained via a continuous gas phase polymerization using supported catalyst comprising an activated molecularly discrete catalyst in the substantial absence of an aluminum alkyl based scavenger (e.g., triethylaluminum (TEAL), trimethylaluminum (TMAL), triisobutyl aluminum (TIBAL), tri-n-hexylaluminum (TNHAL), and the like). Representative LLDPEs produced using these catalysts generally each have a melt index at 190° C./2.16 kg (I_{2.16}) of from 0.1 to 15 g/10 min, a Compositional Distribution Breadth Index (“CDBI”) of at least 70%, a density of from 0.910 to 0.940 g/cm³, a melt index ratio (MIR) at 190° C., I_{2.16}/I_{2.16}, of from 35 to 80.

The LLDPE can be made by a gas phase process using conventional Ziegler-Natta supported catalysts or metallocene-based supported catalysts, for example, those under grade names Exceed™ material made by ExxonMobil Chemical Company and those commercially available SINOPEC using Unipol™ PE process from Univation Technology.

Preferably, the LLDPE polymers of the present invention may have either one or a combination of the following features: a density from about 0.915 to about 0.927 g/cm³, an MI at 190° C./2.16 kg from about 0.3 to about 10 g/10 min, and a CDBI of at least 75%. The DIS is preferably from about 120 to about 1000 g/mil, even more preferably, from about 150 to about 800 g/mil, and the M_{w}/Mₙ by GPC is preferably from about 2.5 to about 10.0.

The present inventive composition may comprise a low density polyethylene (LDPE) polymer as the second component. LDPEs utilized in ethylene-based polymer compositions are generally known to those skilled in the art. Various conventional LDPEs have been commercially manufactured since the 1930s. Preferably, LDPE is prepared by high pressure polymerization using free radical initiators, and typically has a density in the range of 0.910-0.935 g/cm³, for example, from about 0.910 to about 0.930 g/cm³, or from 0.910 to about 0.920 g/cm³. LDPEs may have melt indices at 190° C./2.16 kg (I_{2.16}) in the range of from about 0.1 g/10 min to in excess of 100 g/10 min, for example, from about 0.1 to about 30.0 g/10 min. LDPE is also known as “branched” or “heterogeneously branched” polyethylene because of the relatively large number of long chain branches extending from the main polymer backbone.

In some embodiments, low density polyethylenes can have a g′vis as described below of 0.50 to 0.85, particularly 0.50 to 0.80, 0.50 to 0.75, 0.50 to 0.70, 0.50 to 0.65, 0.50 to 0.60, or 0.50 to 0.55.

Preferably, low density polyethylenes are copolymer of ethylene one or more polar comonomers. Typically, low density polyethylenes useful herein include 99.0 wt. % to about 80.0 wt. %, 99.0 wt. % to 85.0 wt. %, 99.0 wt. % to 87.5 wt. %, 95.0 wt. % to 90.0 wt. %, of polymer units derived from ethylene and about 1.0 wt. % to about 20.0 wt. %, 1.0 wt. % to 15.0 wt. %, 1.0 wt. % to 12.5 wt. %, or 5.0 wt. % to 10.0 wt. % of polymer units derived from one or more polar comonomers.

LDPEs may have a melt index (“MI”), as measured according to ASTM D1238, 2.16 kg, 190° C., of 0.1 to 30.0 g/10 min, such as 0.1 to 12.0 g/10 min, particularly 0.1 to 2.5 g/10 min, 0.2 to 1.0 g/10 min, or 0.3 to 0.7 g/10 min, and a melt index ratio (MIR), the ratio of the melt index ratio at 190° C./21.6 kg to the melt index at 190° C./2.16 kg (Ser. No. 12/164,216), of from 1 to 80, or from 5 to 60, or from 15 to 40.

Preferably, the LDPE polymers of the present invention may have either one or a combination of the following features: a density from about 0.910 to about 0.930 g/cm³, an MI at 190° C./2.16 kg from about 0.1 to about 30 g/10 min, more preferably from 0.3 to 10 g/10 min, an MIR of from about 15 to about 40, and an M_{w}/Mₙ by GPC from about 2.5 to about 10.0.

In some embodiments, the low density polyethylene has a melting point of 40° C. or less, as measured by industry acceptable thermal methods, such as Differential Scanning calorimetry (DSC). In other embodiments, the melting point can may be 40.0° C. to about 90.0° C.; 40.0° C. to 80.0° C.; 50.0° C. to 70.0° C.; 55.0° C. to 65.0° C.; or about 60.0° C.

Low density polyethylene (“LDPE”) may have a Vicat softening point of about 20.0° C. to about 80.0° C., as measured by ASTM D1525. The Vicat softening point can also range from a low of about 20.0° C., 25.0° C., or 30.0° C. to a high of about 35.0° C., 40.0° C., or 50.0° C. The Vicat softening point of the LDPE can also be 20.0° C. to 70.0° C.; 30.0° C. to 60.0° C.; 35.0° C. to 45.0° C.; about 35.0° C., or 40.0° C.

In some embodiments, the LDPE include 0.1 wt. % to 10.0 wt. % units derived from one or more modifiers, based on the total weight of the LDPE. The amount of the modifier(s) can range from a low of about 0.1 wt. %, 0.3 wt. %, or 0.8 wt. % to a high of about 3.0 wt. %, 6.0 wt. %, or 10.0 wt. %, based on the total weight of the LDPE. The amount of the modifier(s) can also range from a low of about 0.2 wt. %, 0.4 wt. %, or 0.8 wt. % to a high of about 1.5 wt. %, 2.5 wt. %, 3.6 wt. %, or 5 wt. %, based on the total weight of the LDPE. The amount of the modifier can also be 0.1 wt. % to 8 wt. %; 0.2 wt. % to 6 wt. %; 0.3 wt. % to 6 wt. %; 0.3 wt. % to 4 wt. %; 0.4 wt. % to 4.0 wt. %; 0.6 wt. % to 4 wt. %; 0.4 wt. % to 3.5 wt. %; or 0.5 wt. % to 3.8 wt. %, based on the total weight of the LDPE.

Suitable modifiers, also called chain transfer agents, are described in Advances in Polymer Science, Volume 7, pp. 386-448, 1970. Particular modifiers are C₂ to C₁₂ unsaturated modifiers containing at least one unsaturation, but they can also contain multiple conjugated or non-conjugated unsaturations. In the case of multiple unsaturations, it is preferred that they are non-conjugated. In certain embodiments, the unsaturation of the C₂ to C₁₂ unsaturated modifier can be di-substituted with one or more alkyl groups in the beta position. Preferred C₂ to C₁₂ unsaturated modifiers include propylene, isobutylene, or a combination thereof.

Low density polyethylene can also contain one or more antioxidants. Phenolic antioxidants are preferred, such as butylated hydroxytoluene (BHT) or other derivatives containing butylated hydroxytoluene units such as Irganox 1076 or Irganox 1010 and alike. The antioxidant can be present in an amount less than 0.05 wt. %, based on the total weight of the resin. When present, for example, the amount of the one or more antioxidants can range from a low of about 0.001 wt. %, 0.005 wt. %, 0.01 wt. %, or 0.015 wt. % to a high of about 0.02 wt. %, 0.03 wt. %, 0.04 wt. %, or 0.05 wt. %.

Low density polyethylene can further contain one or more additives. Suitable additives can include, but are not limited to: stabilization agents such as antioxidants or other heat or light stabilizers; anti-static agents; crosslink agents or co-agents; crosslink promotors; release agents; adhesion promotors; plasticizers; or any other additive and derivatives known in the art. Suitable additives can further include one or more anti-agglomeration agents, such as oleamide, stearamide, erucamide, or other derivatives with the same activity as known to the person skilled in the art. Preferably, the LDPE resin contains less than 0.15 wt. % of such additives, based on the total weight of the resin. When present, the amount of the additives can also range from a low of about 0.01 wt. %, 0.02 wt. %, 0.03 wt. %, or 0.05 wt. % to a high of about 0.06 wt. %, 0.08 wt. %, 0.11 wt. %, or 0.15 wt. %.

Useful low density polyethylenes can be available from ExxonMobil Chemical Company as ExxonMobil™ LDPE or Nexxstar™ resins.

### Grafted Polyolefin-Based Polymer

As described herein, the term “grafted polyolefin-based polymer”, shall mean those polyolefin-based polymers, such as, but not limited to, the propylene-based elastomers and the ethylene-based polymers as described herein, grafted with graft comonomers, such as, but not limited to, ethylenically unsaturated carboxylic acids or acid derivatives or epoxides, and thereby provided with polarity.

Examples of acid derivatives suitable for use in the present invention include acid anhydrides, esters, salts, amides, imides, and the like. A particularly preferred acid derivative is maleic anhydride (“MAH”). Other suitable graft comonomers of this type include, but are not limited to the following: acrylic acid, methacrylic acid, maleic acid, fumaric acid, itaconic acid, citraconic acid, mesaconic acid, crotonic acid, maleic anhydride, 4-methyl cyclohex-4-ene-1,2-dicarboxylic acid anhydride, bicyclo(2.2.2)oct-5-ene-2,3-dicarboxylic acid anhydride, 1,2,3,4,5,8,9,10-octahydronaphthalene-2,3-dicarboxylic acid anhydride, 2-oxa-1,3-diketospiro(4.4)non-7-ene, bicyclo(2.2.1)hept-5-ene-2,3-dicarboxylic acid anhydride, maleopimaric acid, tetrahydrophtalic anhydride, norborn-5-ene-2,3-dicarboxylic acid anhydride, nadic anhydride, methyl nadic anhydride, himic anhydride, methyl himic anhydride, and x-methyl-bicyclo(2.2.1)hept-5-ene-2,3-dicarboxylic acid anhydride (“XMNA”). As used herein, the term “graft” or “grafting” denotes covalent bonding of the graft comonomer to a polymer chain of the propylene-based elastomer.

Certain suitable epoxide graft comonomers may be described as a monovalent group of the general formula:

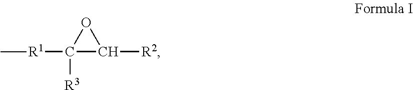

wherein R³ is hydrogen or methyl; R² is hydrogen or C₁-C₆ alkyl; and IV is C₁-C₁₀ alkylene. Preferably R¹ is methylene, R² is hydrogen and R³ is hydrogen (i.e. glycidyl). The above epoxide graft comonomer of Formula I may be joined to the alpha-beta ethylenically unsaturated portion of the propylene-based elastomer backbone through any number of organic groups including a carbon-to-carbon bond, through an amide group, through an ether linkage or through an ester linkage. Suitable epoxide graft comonomers are glycidal esters of unsaturate alcohols, glycidal esters of unsaturated carboxylic acids, glycidal esters of alkenylphenols, vinyl and allyl esters of expoxy carboxylic acids and vinyl esters of expoxidized oleic acid. A particularly preferred epoxide graft comonomer is glycidyl methacrylate (“GMA”). Other suitable grafting comonomers of these types include, but are not limited to the following: glycidyl acrylate, allyl-glycidal ether, methallyl-glycidal ether, glycidyl-2-ethyl acrylate, glycidyl-2-propyl acrylate, and isopropenylphenyl-glycidyl ethers.

Other examples of functional graft comonomers suitable for use in at least one embodiment of the present invention may be generally described as C₁-C₈ alkyl esters derivatives of unsaturated carboxylic acids. Some of these comonomers include, but are not limited to, methyl acrylate, methyl methacrylate, ethyl acrylate, ethyl methacrylate butyl acrylate, butyl methacrylate monoethyl maleate, diethyl maleate, monomethyl fumarate, dimethyl fumarate monomethyl itaconate and diethyle itaconate. The graft comonomers suitable for use in the present invention may also be a mixture of more than one of any of the above described graft comonomers.

Generally the compatibilizing effect between the first component and the third component is influenced by the level of grafting in the polyolefin-based polymer, such as propylene-based elastomer. The polyolefin-based polymer may be grafted to a higher degree. The amount of grafting comonomers units is within the range having an upper limit of 10.0 wt. %, 5.0 wt. %, 2.0 wt. %, 1.6 wt. %, 1.5 wt. % or 1.0 wt. % and a lower limit of 0.1 wt. %, 0.3 wt. %, 0.5 wt. % or 0.6 wt. %, based on the total weight of the grafted polyolefin-based polymer.

Methods for preparation of the grafted polyolefin-based polymers are not particularly restricted. For example, suitable grafted propylene-based elastomers are described or prepared in U.S. Pat. No. 6,884,850, which is incorporated by reference herein for all jurisdictions where such incorporation is permitted. Suitable grafted ethylene-based polymers can comprise Exxelor™ maleicanhydride functionalized elastomeric ethylene copolymers.

### Tackifier

Suitable tackifiers include, but are not limited to, aliphatic tackifiers, at least partially hydrogenated aliphatic tackifiers, aliphatic/aromatic tackifiers, at least partially hydrogenated aliphatic aromatic tackifiers, aromatic resins, at least partially hydrogenated aromatic tackifiers, cycloaliphatic tackifiers, at least partially hydrogenated cycloaliphatic resins, cycloaliphatic/aromatic tackifiers, cycloaliphatic/aromatic at least partially hydrogenated tackifiers, polyterpene resins, terpene-phenol resins, rosin esters, rosin acids, grafted resins, and mixtures of two or more of the foregoing. The tackifiers are polar.

In any embodiment, suitable tackifiers may comprise one or more tackifiers produced by the thermal polymerization of cyclopentadiene (CPD) or substituted CPD, which may further include aliphatic or aromatic monomers as described later. The tackifier may be a non-aromatic resin or an aromatic resin. The tackifier may have an aromatic content between 0 wt. % and 60 wt. %, or between 1 wt. % and 60 wt. %, or between 1 wt. % and 40 wt. %, or between 1 wt. % and 20 wt. %, or between 10 wt. % and 20 wt. %. Alternatively or additionally, the tackifier may have an aromatic content between 15 wt. % and 20 wt. %, or between 1 wt. % and 10 wt. %, or between 5 wt. % and 10 wt. %. Preferred aromatics that may be in the tackifier include one or more of styrene, indene, derivatives of styrene, and derivatives of indene. Particularly, preferred aromatic olefins include styrene, alpha-methylstyrene, beta-methylstyrene, indene, and methylindenes, and vinyl toluenes. Styrenic components include styrene, derivatives of styrene, and substituted styrenes. In general, styrenic components do not include fused-rings, such as indenics.

In any embodiment, suitable tackifiers may comprise tackifiers produced by the catalytic (cationic) polymerization of linear dienes. Such monomers are primarily derived from Steam Cracked Naphtha (SCN) and include C₅ dienes such as piperylene (also known as 1,3-pentadiene). Polymerizable aromatic monomers can also be used to produce resins and may be relatively pure, e.g., styrene, methyl styrene, or from a C₉-aromatic SCN stream. Such aromatic monomers can be used alone or in combination with the linear dienes previously described. “Natural” monomers can also be used to produce resins, e.g., terpenes such as alpha-pinene or beta-carene, either used alone or in high or low concentrations with other polymerizable monomers. Typical catalysts used to make these resins are AlCl₃ and BF₃, either alone or complexed. Mono-olefin modifiers such as 2-methyl, 2-butene may also be used to control the MWD of the final resin. The final resin may be partially or totally hydrogenated.

In any embodiment, suitable tackifiers may be at least partially hydrogenated or substantially hydrogenated. As used herein, “at least partially hydrogenated” means that the material contains less than 90% olefinic protons, or less than 75% olefinic protons, or less than 50% olefinic protons, or less than 40% olefinic protons, or less than 25% olefinic protons, such as from 20% to 50% olefinic protons. As used herein, “substantially hydrogenated” means that the material contains less than 5% olefinic protons, or less than 4% olefinic protons, or less than 3% olefinic protons, or less than 2% olefinic protons, such as from 1% to 5% olefinic protons. The degree of hydrogenation is typically conducted so as to minimize and avoid hydrogenation of the aromatic bonds.

In any embodiment, suitable tackifiers may comprise one or more oligomers such as dimers, trimers, tetramers, pentamers, and hexamers. The oligomers may be derived from a petroleum distillate boiling in the range of 30° C. to 210° C. The oligomers may be derived from any suitable process and are often derived as a byproduct of resin polymerization. Suitable oligomer streams may have an Mn between 130 and 500, or between 130 and 410, or between 130 and 350, or between 130 and 270, or between 200 and 350, or between 200 and 320. Examples of suitable oligomer streams include, but are not limited to, oligomers of cyclopentadiene and substituted cyclopentadiene, oligomers of C₄-C₆ conjugated diolefins, oligomers of C₈-C₁₀ aromatic olefins, and combinations thereof. Other monomers may be present. These include C₄-C₆ mono-olefins and terpenes. The oligomers may comprise one or more aromatic monomers and may be at least partially hydrogenated or substantially hydrogenated.

Preferably, suitable tackifiers comprises a dicyclopentadiene, cyclopentadiene, and methylcyclopentadiene derived content of about 60 wt. % to about 100 wt. % of the total weight of the tackifier. In any embodiment, suitable tackifiers may have a dicyclopentadiene, cyclopentadiene, and methylcyclopentadiene derived content of about 70 wt. % to about 95 wt. %, or about 80 wt. % to about 90 wt. %, or about 95 wt. % to about 99 wt. % of the total weight of the tackifier. Preferably, the tackifier may be a tackifier that includes, in predominant part, dicyclopentadiene derived units. The term “dicyclopentadiene derived units”, “dicyclopentadiene derived content”, and the like refers to the dicyclopentadiene monomer used to form the polymer, i.e., the unreacted chemical compound in the form prior to polymerization, and can also refer to the monomer after it has been incorporated into the polymer, which by virtue of the polymerization reaction typically has fewer hydrogen atoms than it does prior to the polymerization reaction.

In any embodiment, suitable tackifiers may have a dicyclopentadiene derived content of about 50 wt. % to about 100 wt. % of the total weight of the tackifier, more preferably about 60 wt. % to about 100 wt. % of the total weight of the tackifier, even more preferably about 70 wt. % to about 100 wt. % of the total weight of the tackifier. Accordingly, in any embodiment, suitable tackifiers may have a dicyclopentadiene derived content of about 50% or more, or about 60% or more, or about 70% or more, or about 75% or more, or about 90% or more, or about 95% or more, or about 99% or more of the total weight of the tackifier.

Suitable tackifiers may include up to 5 wt. % indenic components, or up to 10 wt. % indenic components. Indenic components include indene and derivatives of indene. Often, the tackifier includes up to 15 wt. % indenic components. Alternatively, the tackifier is substantially free of indenic components.

Preferred tackifiers have a melt viscosity of from 300 to 800 centipoise (cPs) at 160° C., or more preferably of from 350 to 650 cPs at 160° C. Preferably, the melt viscosity of the tackifier is from 375 to 615 cPs at 160° C., or from 475 to 600 cPs at 160° C. The melt viscosity may be measured by a Brookfield viscometer with a type “J” spindle according to ASTM D 6267.

Suitable tackifiers have an Mw greater than about 600 g/mole or greater than about 1000 g/mole. In any embodiment, the tackifier may have an Mw of from about 600 to about 1400 g/mole, or from about 800 g/mole to about 1200 g/mole. Preferred tackifiers have a weight average molecular weight of from about 800 to about 1000 g/mole. Suitable tackifiers may have an Mn of from about 300 to about 800 g/mole, or from about 400 to about 700 g/mole, or more preferably from about 500 to about 600 g/mole. Suitable tackifiers may have an Mz of from about 1250 to about 3000 g/mole, or more preferably from about 1500 to about 2500 g/mole. In any embodiment, suitable tackifiers may have an Mw/Mn of 4 or less, preferably from 1.3 to 1.7.

Preferred tackifiers have a glass transition temperature (Tg) of from about 30° C. to about 200° C., or from about 0° C. to about 150° C., or from about 50° C. to about 160° C., or from about 50° C. to about 150° C., or from about 50° C. to about 140° C., or from about 80° C. to about 100° C., or from about 85° C. to about 95° C., or from about 40° C. to about 60° C., or from about 45° C. to about 65° C. Preferably, suitable tackifiers have a Tg from about 60° C. to about 90° C. DSC is used to determine glass transition temperature at 10° C./min.

Specific examples of commercially available tackifiers include Escorez™ hydrocarbon resins available from ExxonMobil Chemical Company, ARKON™ M90, M100, M115 and M135 and SUPER ESTER™ rosin esters available from Arakawa Chemical Company of Japan, SYLVARES™ phenol modified styrene- and methyl styrene resins, styrenated terpene resins, ZONATAC terpene-aromatic resins, and terpene phenolic resins available from Arizona Chemical Company, SYLVATAC™ and SYLVALITE™ rosin esters available from Arizona Chemical Company, NORSOLENE™ aliphatic aromatic resins available from Cray Valley of France, DERTOPHENE™ terpene phenolic resins available from DRT Chemical Company of Landes, France, EASTOTAC™ resins, PICCOTACT™ C5/C9 resins, REGALITE™ and REGALREZ™ aromatic and REGALITE™ cycloaliphatic/aromatic resins available from Eastman Chemical Company of Kingsport, Tenn., WINGTACK™ ET and EXTRA available from Goodyear Chemical Company, FORAL™, PENTALYN™, AND PERMALYN™ rosins and rosin esters available from Hercules (now Eastman Chemical Company), QUINTONE™ acid modified C₅ resins, C₅/C₉ resins, and acid modified C₅/C₉ resins available from Nippon Zeon of Japan, and LX™ mixed aromatic/cycloaliphatic resins available from Neville Chemical Company, CLEARON hydrogenated terpene aromatic resins available from Yasuhara. The preceding examples are illustrative only and by no means limiting.

These commercial compounds generally have a Ring and Ball softening point (measured according to ASTM E-28 (Revision 1996)) of about 10° C. to about 200° C., more preferably about 50° C. to about 180° C., more preferably about 80° C. to about 175° C., more preferably about 100° C. to about 160° C., more preferably about 110° C. to about 150° C., and more preferably about 125° C. to about 140° C., wherein any upper limit and any lower limit of softening point may be combined for a preferred softening point range. For tackifiers a convenient measure is the ring and ball softening point determined according to ASTM E-28.

### Differentiated Polyethylene

Copolymers produced with ethylene and a polar comonomer as described herein may be referred to as “Differentiated polyethylenes (“DPE”). Typically, the DPE includes about 99.0 wt. % to about 50.0 wt. %, about 99.0 wt. % to about 60.0 wt. %, about 99.0 wt. % to about 70.0 wt. %, about 95.0 wt. % to about 80.0 wt. %, of polymer units derived from ethylene and about 1.0 wt. % to about 50.0 wt. %, about 1.0 wt. % to about 40.0 wt. %, about 1.0 wt. % to about 30.0 wt. %, or about 5.0 wt. % to about 20.0 wt. % of polymer units derived from one or more polar comonomers, based upon the total weight of the polymer. Suitable polar comonomers include, but are not limited to: vinyl ethers such as vinyl methyl ether, vinyl n-butyl ether, vinyl phenyl ether, vinyl beta-hydroxy-ethyl ether, and vinyl dimethylamino-ethyl ether; olefins such as propylene, butene-1, cis-butene-2, trans-butene-2, isobutylene, 3,3,-dimethylbutene-1,4-methylpentene-1, octene-1, and styrene; vinyl type esters such as vinyl acetate, vinyl butyrate, vinyl pivalate, and vinylene carbonate; haloolefins such as vinyl fluoride, vinylidene fluoride, tetrafluoroethylene, vinyl chloride, vinylidene chloride, tetrachloroethylene, and chlorotrifluoroethylene; acrylic-type esters such as methyl acrylate, ethyl acrylate, n-butyl acrylate, t-butyl acrylate, 2-ethylhexyl acrylate, alpha-cyanoisopropyl acrylate, beta-cyanoethyl acrylate, o-(3-phenylpropan-1,3,-dionyl)phenyl acrylate, methyl methacrylate, n-butyl methacrylate, t-butyl methacrylate, cyclohexyl methacrylate, 2-ethylhexyl methacrylate, methyl methacrylate, glycidyl methacrylate, beta-hydroxethyl methacrylate, beta-hydroxpropyl methacrylate, 3-hydroxy-4-carbo-methoxy-phenyl methacrylate, N,N-dimethylaminoethyl methacrylate, t-butylaminoethyl methacrylate, 2-(1-aziridinyl)ethyl methacrylate, diethyl fumarate, diethyl maleate, and methyl crotonate; other acrylic-type derivatives such as acrylic acid, methacrylic acid, crotonic acid, maleic acid, methyl hydroxy maleate, itaconic acid, acrylonitrile, fumaronitrile, N,N-dimethylacrylamide, N-isopropylacrylamide, N-t-butylacrylamide, N-phenylacrylamide, diacetone acrylamide, methacrylamide, N-phenylmethacrylamide, N-ethylmaleimide, and maleic anhydride; and other compounds such as allyl alcohol, vinyltrimethylsilane, vinyltriethoxysilane, N-vinylcarbazole, N-vinyl-N-methyl acetamide, vinyldibutylphosphine oxide, vinyldiphenylphosphine oxide, bis-(2-chloroethyl) vinylphosphonate, and vinyl methyl sulfide.

In some embodiments, the DPE is an ethylene/acrylic acid copolymer having about 2.0 wt. % to about 15.0 wt. %, typically about 5.0 wt. % to about 10.0 wt. %, polymer units derived from acrylic acid, based on the amounts of polymer units derived from ethylene and acrylic acid (EAA). In certain embodiments, the EAA resin can further include polymer units derived from one or more comonomer units selected from propylene, butene, 1-hexene, 1-octene, and/or one or more dienes.

Suitable dienes include, for example, 1,4-hexadiene, 1,6-octadiene, 5-methyl-1,4-hexadiene, 3,7-dimethyl-1,6-octadiene, dicyclopentadiene (DCPD), ethylidene norbornene (ENB), norbornadiene, 5-vinyl-2-norbornene (VNB), and combinations thereof.

Suitable DPE include Escorene™ Ultra EVA resins, Escor™ EAA resins, ExxonMobil™ EnBA resins, and Optema™ EMA resins available from ExxonMobil Chemical Company, Houston, Tex.

### Fillers

The present inventive compositions comprise filler, as a fourth component. Suitable fillers can be organic fillers and/or inorganic fillers. Suitable fillers include such materials as carbon black, fly ash, graphite, cellulose, starch, polyester-based material, and polyamide-based materials, metal oxides and metal inorganic slats. Preferred examples of fillers are calcium carbonate, aluminum trihydrate, talc, glass fibers, marble dust, cement dust, clay, feldspar, silica or glass, fumed silica, alumina, magnesium oxide, antimony oxide, zinc oxide, barium sulfate, calcium sulfate, aluminum silicate, calcium silicate, calcium carbonate, titanium dioxide, titanates, clay, nanoclay, organo-modified clay or nanoclay, glass microspheres, and chalk. Fillers improving flame retardant properties, such as aluminum trihydrate, are mostly preferred in some embodiments. Particular useful fillers in the present disclosure include fly ash, ground glass, calcium carbonate, talc, and clay.

In some embodiments, two or more fillers can be used. For example, both calcium carbonate and barium sulfate are preferred for. Other combinations of fillers can vary from needs.

### Other Additives

As will be evident to those skilled in the art, the polymer compositions of the present disclosure may comprise other additives, in addition to the first to fourth components, to adjust the characteristics of the composition as desired. Various additives may be incorporated to enhance a specific property or may be incorporated as a result of processing of the individual components. Additives which may be incorporated include, but are not limited to, processing oils, processing aids, fire retardants, antioxidants, flow improvers, coloring agents, reinforcements, and adhesive additives.

The compositions may contain processing oils and processing aids. Paraffinic oil, naphthenic oil or polyalphaolefin (PAO) fluid are suitable processing oils for use in the composition of present disclosure. The processing oil can be present in an amount of up to 10 wt. %, or from about 0.1 wt. % to about 10 wt. %, or from about 0.5 wt. % to about 8 wt. %, or from about 1 wt. % to about 5 wt. %, by weight of the composition. Additional processing aids include waxes, fatty acid salts, such as calcium stearate or zinc stearate, alcohols, including glycols, glycol ethers, alcohol ether, (poly) esters including (poly) glycol esters and salts to one particular ethnic group or two metal or zinc salt derivatives.

The compositions may contain a coupling agent. As used herein, the term “coupling agent” is meant to refer to any agent capable of facilitating stable chemical and/or physical interaction between two otherwise non-interacting species, e.g., between a filler and an elastomer. The coupling agent may be organic or inorganic, for example, an organic peroxide-based coupling agent, a polyamine coupling agent, a resin coupling agent. Examples of useful coupling agent can comprise aluminate coupling agent, titanate coupling agent. The coupling agent can be present in an amount of up to 10 wt. %, or from about 0.1 wt. % to about 10 wt. %, or from about 0.5 wt. % to about 8 wt. %, or from about 1 wt. % to about 5 wt. %, by weight of the composition.

The compositions may contain a heat stabilizer and/or antioxidant. Hindered amine stabilizers, e.g., CHIMASSORB™ available from Ciba Specialty Chemicals, are exemplary heat and light stabilizers. Further, hindered phenols can be used as an antioxidant. Some suitable hindered phenols include those available from Ciba Specialty Chemicals of under the trade name Irganox™. When employed, the antioxidant and/or the stabilizer, may each be present in an amount of up to about 10 wt. %, for example, from about 0.1 wt. % to about 20 wt. %, or from about 0.5 wt. % to about 15 wt. %, or from 1 wt. % to about 10 wt. %, by weight of the composition.

### Compositions, Heavy Layers, and Making Thereof

The present compositions may comprise from about 5 wt. % to about 25 wt. % of a first component comprising the propylene-based elastomer. In some embodiments, the heavy layer composition can comprise from about 8 wt. % to about 20 wt. %, or from 10 wt. % to about 20 wt. %, or from 10 wt. % to about 15 wt. % of the propylene-based elastomer, based on the weight of the composition. In some embodiments, the present composition may comprise one or two or more propylene-based elastomers.

The present compositions may comprise from about 1 wt. % to about 25 wt. % of a second component comprising the ethylene-based elastomer. In some embodiments, the heavy layer composition can comprise from about 5 wt. % to about 25 wt. %, or from about 8 wt. % to about 20 wt. %, or from 10 wt. % to about 20 wt. %, or from 10 wt. % to about 15 wt. % of the ethylene-based polymer, based on the weight of the composition. In some embodiments, the present composition may comprise one or two or more ethylene-based polymers.

The present compositions may comprises from about 0.5 wt. % to about 15 wt. % of a third component. In some embodiments, the heavy layer composition can comprise from about 1 wt. % to about 15 wt. %, or from about 2 wt. % to about 12 wt. %, or from 2 wt. % to about 10 wt. %, or from 3 wt. % to about 8 wt. %, or from about 3 wt. % to about 5 wt. % of the third component, based on the weight of the composition. In some embodiments, the present composition may comprise one or two or more selected from the tackifier, the grafted polyolefin-based polymer, and the DPE. In most preferred embodiments, the third component comprises tackifier.

The present compositions may comprise from about 50 wt. % to about 90 wt. % of a fourth component comprising the filler. In some embodiments, the heavy layer composition can comprise from about 50 wt. % to about 80 wt. %, or from about 55 wt. % to about 75 wt. %, or from 60 wt. % to about 75 wt. %, or from 65 wt. % to about 75 wt. % of the filler, based on the weight of the composition. In some embodiments, the present composition may comprise one or two or more fillers, for example, calcium carbonates, barium sulfate, and carbon black.

Other additives may be optionally present in the compositions. The total amount of other additives added can range from about 0.1 wt. % to about 25 wt. %, or from about 0.1 wt. % to about 20 wt. %, or from 0.1 wt. % to about 15 wt. %, or from 0.1 wt. % to about 10 wt. % based on the weight of the layer or the polymer composition used to form the layer.

The compositions according to this disclosure may be compounded by any known method. For example, the compounding may be carried out in a continuous mixer such as a Brabender mixer, a mill or an internal mixer such as Banbury mixer. The compounding may also be conducted in a continuous process such as a twin screw extruder.

In a particular embodiment, the various components can first mixed using a high-speed mixer, followed by twin screw extruder, and then a single screw extruder so as to obtain a well-mixed composition. After the components are mixed as above, the mixture can go through one or more, for example, three rollers to adjust the thickness to form the heavy layers. Optionally, the heavy layers can be further treated, for example, by corona, or by other chemical method to improve the bonding ability of the surface of heavy layers.

The type and intensity of mixing, temperature, and residence time required can be achieved by the choice of one of the above machines in combination with the selection of mixing elements, screw design, and screw speed.

Typically, a pyramid temperature profile is preferred when making the composition using an extruder. In the first few zones of the extruder, the temperature can be from 100° C. to 150° C., and 150° C. to 250° C. in the intermediate few zones, and 120° C. to 220° C. in the last few zones. The temperature in the die can be from 100° C. to 250° C. The residence time in the extruder can be from 1 to 60 minutes, or from 3 to 30 minutes.

In some embodiments, the compositions and heavy layers made therefrom can have at least one of the following properties:
a Shore A hardness of less than about 95, less than about 90, less than about 88, or less than about 85; and
an elongation at break of at least 180%, or at least about 200%, or at least about 300%, or at least about 400%.

### Applications

The present invention also includes a composite material comprising a first layer made from the inventive compositions and at least one second layer bonded onto the first layer. The second layer can be made from polar or non-polar material, for example, polyethylenes, polyurethanes etc. In preferred embodiments, the composite material is a front wall and the second layer is a polyurethane foam layer.

In some embodiments, the composite material can comprises additional layers other than the first and the second layers.

The composite material described herein may be formed by any of the conventional techniques known in the art. Illustrative methods include thermoforming process, compression molding process, and lamination process etc.

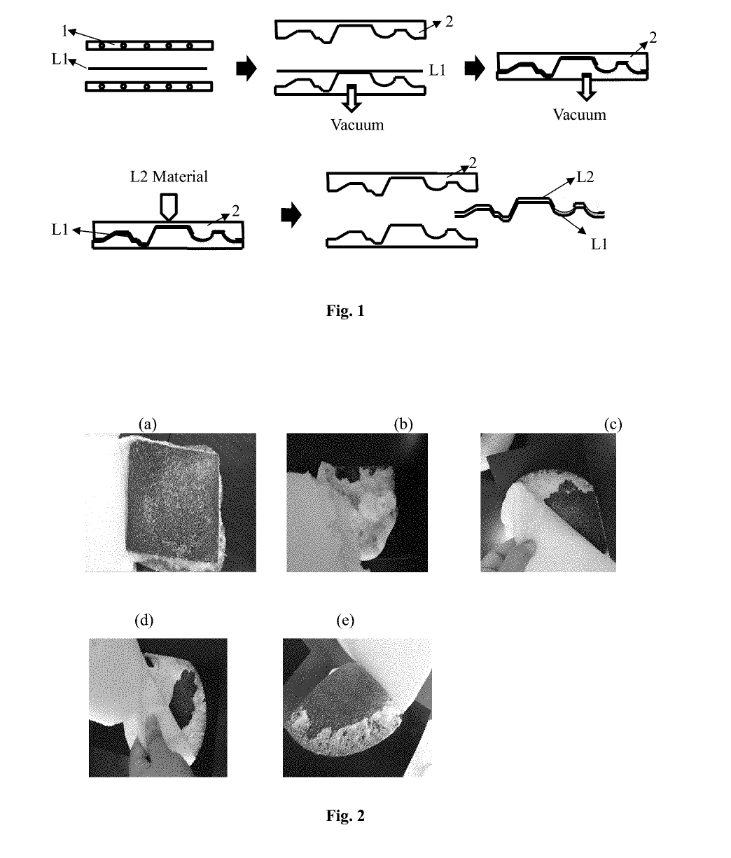

FIG. 1 shows a thermoforming process for making composite material, such as automobile front walls, in which a heavy layer L1 made from the present composition is first heated to become soft in heater 1, such as an oven, and placed through an opened mold 2 having upper and lower molding plates, which are then closed and vacuumed, the second layer material, e.g., the raw material for synthesis of polyurethane, such as isocyanate and polybasic alcohol, is then injected into the mold so as to synthesize and bond a polyurethane foam layer L2 onto the heavy layer L1.

Other suitable uses of the present compositions and heavy layers include carpet, dashboard, insulators, floor mat, automobile front/rear walls and so on that are used for sound-proofing and/or vibration absorption, as well as other highly filled applications.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

### Testing Methods

Shore A hardness was measured according to ASTM D-2240.

Elongation at Break was measured according to ASTM D-638.

### Materials

Vistamaxx™ 6202 polymer (“PBE”) is a propylene-based elastomer having about 15 wt. % of ethylene-derived units with the remaining of propylene-derived units, and having a vicat softening temperature 47.2° C., a density of about 0.863 g/cm3, and an MFR (230° C., 2.16 kg) of about 20 g/10 min, and is commercially available from ExxonMobil Chemical Company, TX.

LLDPE 7042 (“LLDPE”) was a linear low density polyethylene having a typical density of 0.920 g/cm3, a typical melt flow rate of 2.0 g/10 min (230° C., 2.16 kg), commercially available from Sinopec, China.

Grafted propylene-based elastomer (“G-PBE”) was Vistamaxx™ 6102 polymer grafted with maleic anhydride. G-PBE has a melt flow rate of about 30.7 g/10 min (230° C., 2.16 kg), a grafted maleic anhydride content of about 0.52 wt. %, and residual maleic anhydride content of about 0.13 wt. %. Vistamaxx™ 6102 polymer is a propylene-based elastomer having about 16 wt. % of ethylene-derived units with the remaining of propylene-derived units, and having a vicat softening temperature 52.2° C., a density of about 0.862 g/cm3, and an MFR (230° C., 2.16 kg) of about 3 g/10 min, and is commercially available from ExxonMobil Chemical Company, TX.

Escorez™ 5615 tackifier resins (“TR”) is an aromatic modified, cycloaliphatic hydrocarbon resin, having a softening point of 117.8 C, an aromaticity (aromatic protons) of 9.9%, commercially available from ExxonMobil Chemical Company, TX.

Escor™ 5100 resin (“EAA”) is an ethylene acrylic acid copolymer having a density of 0.940 g/cm³, an acrylic acid content of about 11.0 wt. %, a melt index of 8.5 g/10 min (190° C., 2.16 kg), commercially available from ExxonMobil Chemical Company, TX.

Calcium carbonate (CaCO₃), Barium sulfate (BaSO₄), and Carbon black (“CB”) were commercially available from the market. Coupling agent (“CPA”) was an aluminate coupling agent. Processing Oil (“Oil”) was white oil.

### Examples 1-5

Compositions of examples 1 to 5 as shown in Table 1 were mixed according to by the following process to from heavy layers: all components were pre-mixed in a high-speed blade mixer, and then a twin screw extruder, and a single screw extruder with T die, followed by going through three rollers to cool and adjust the thickness to form the heavy layers. The heavy layers were then trimmed and surface treated by corona. Some processing conditions are shown in Tables 2, 3, and 4. Hardness and elongation properties were tested. Results are shown in Table 5.

TABLE 1
Formulations

| | Example | | | | |
|---|---|---|---|---|---|
| | 1 | | | | |
| | (comparative) | 2 | 3 | 4 | 5 |
| BaSO₄ (kg) | 50 | 50 | 50 | 50 | 50 |
| CaCO₃ (kg) | 100 | 100 | 100 | 100 | 100 |
| LLDPE (kg) | 18 | 15 | 20 | 20 | 20 |
| PBE (kg) | 35 | 32 | 30 | 30 | 30 |
| TR (kg) | | 6 | 10 | | |
| G-PBE (kg) | | | | 10 | |
| EAA (kg) | | | | | 10 |
| CPA (kg) | 1.5 | 1.5 | 1.5 | 1.5 | 1.5 |
| Oil (kg) | 1.5 | 1.5 | 1.5 | 1.5 | 1.5 |
| CB (kg) | 0.4 | 0.4 | 0.4 | 0.4 | 0.4 |

TABLE 2
Temperature settings of the twin screw extruder

| | From feeder to die | | | | | | | | |
|---|---|---|---|---|---|---|---|---|---|
| Zone Number | 1 | 2 | 3 | 4 | 5 | 6 | 7 | 8 | 9 |
| Set Temper- | 100-145 | 115-150 | 130-155 | 145-160 | 145-170 | 155-175 | 140-155 | 165-175 | 165-170 |
| ature (° C.) | | | | | | | | | |

TABLE 3
Temperature settings of the single screw extruder

| Zone number | 1 | 2 | 3 | 4 | 5 | 6 |
|---|---|---|---|---|---|---|
| Set Temper- | 150-175 | 145-180 | 155-180 | 155-195 | 155-205 | 175-200 |
| ature (° C.) | | | | | | |

TABLE 4
Temperature setting of the T die

| Zone number | 1 | 2 | 3 | 4 | 5 | 6 |
|---|---|---|---|---|---|---|
| Set Temper- | 65-165 | 145-170 | 165-195 | 165-210 | 175-215 | 160-220 |
| ature (° C.) | | | | | | |

TABLE 5
Hardness and Elongation Properties

| | Example | | | | |
|---|---|---|---|---|---|
| | 1 | | | | |
| | (comparative) | 2 | 3 | 4 | 5 |
| Hardness, shore A | 84 | 84 | 80 | 88 | 94 |
| Elongation at break at | 443 | 414 | 432 | 181 | 24 |
| Room temperature | | | | | |
| (~25° C.), % | | | | | |

### Bonding Test

Plaques sized at 20 cm*10 cm were made using corona-treated heavy layers made from examples 1 to 5, and isocynate and polybasic alcohol were mixed to form 50 ml PU foam material and then poured onto the corona-treated surface of the heavy layers and left foaming freely without any pressure applied at room temperature. After foaming completed and cooling for about 15 minutes, the bonded composite material comprising the heavy layer and PU foam layer was manually delaminated. The manner of delamination of each composite material was visually observed to determine the bonding strength. The delamination is shown in FIG. 2, in which (a) to (e) represents the delamination of composite material using heavy layers made in examples 1 to 5, respectively.

It can be seen from FIG. 2 that use of the present compositions improved bonding strength between the heavy layer and PU foam. FIG. 2 (a) shows a weak bonding strength as very little PU foam was left on the plaque made from the composition of example 1, which comprises no third polar component. “Fiber tear”, shown in FIGS. 2 (b)-(e) indicates a strong bonding strength, was observed from the delamination of the PU foam layer from the heavy layers made from compositions of examples 2 to 5, which comprise use of a third polar component.

The bonding test was conducted without applying any pressure at room temperature (about 25° C.), and when using the thermoforming process in the industry that generally has a higher pressure that the test described herein, one can anticipate the bonding strength can be further improved without any doubt.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. For example, the compositions described herein may be free of any component, or composition not expressly recited or disclosed herein. Any method may lack any step not recited or disclosed herein. Likewise, the term “comprising” is considered synonymous with the term “including.” And whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

What is claimed is:

1. A composition comprising, based on the weight of the composition:
(i) from 3 wt. % to 25 wt. % of a first component comprising a propylene-based elastomer, the propylene-based elastomer comprises at least 75 wt. % of propylene-derived units and less than 25 wt. % of units derived from at least one of ethylene and C₄-C₂₀ alpha-olefins, based on the weight of the propylene-based elastomer, and has an mm propylene triad tacticity by ¹³C NMR of at least 75%, and a heat of fusion of less than 75 J/g;
(ii) from 1 wt. % to 25 wt. % of a second component comprising an ethylene-based polymer, the ethylene-based polymer comprises at least 80 wt. % of ethylene-derived units and less than 20 wt. % of units derived from C₃-C₁₂ alpha olefins, and has a density of less than 0.940 g/cm³ and a melt index at 190° C./2.16 kg (I_{2.16}) of from 0.1 to 40 g/10 min;
(iii) from 0.5 wt. % to 15 wt. % of a third component having polarity; and
(iv) from 50 wt. % to 90 wt. % of a filler.

2. The composition of claim 1 comprising from about 10 wt. % to about 20 wt. % of the first component.

3. The composition of claim 1, wherein the propylene-based elastomer comprises from 80 wt. % to 97 wt. % of propylene-derived units and from 3 wt. % to 20 wt. % of ethylene-derived units.

4. The composition of claim 1 comprising from about 5 wt. % to about 15 wt. % of the second component.

5. The composition of claim 1, wherein the ethylene-based polymer has at least one of the following properties:
(i) a density of from 0.910 g/cm³ to 0.930 g/cm³;
(ii) a melt index at 190° C./2.16 kg (I_{2.16}) of from about 0.1 g/10 min to about 30 g/10 min;
(iii) a melt index ratio of a melt index at 190° C./21.6 kg to a melt index 190° C./2.16 (I_{21.6}/I_{2.16}) of from about 15 to about 40; and
(iv) a molecular weight distribution (M_{w}/Mₙ) of from about 2.5 to about 10.

6. The composition of claim 1 comprising from about 2 wt. % to 10 wt. % of the third component.

7. The composition of claim 1, wherein the third component comprises at least one of:
(a) a tackifier,
(b) a grafted polyolefin-based polymer, and
(c) an ethylene copolymer containing a polar comonomer.

8. The composition of claim 1, wherein the third component comprises a copolymer of ethylene and at least one polar comonomer selected from vinyl acetate, methyl acetate, butyl acetate, and acrylic acid, and wherein the copolymer comprises from 5 wt. % to 30 wt. % of the polar comonomers based on the weight of the copolymer.

9. The composition of claim 1, wherein the third component comprises a grafted propylene-based elastomer comprising, based on the weight of the grafted propylene-based elastomer,
(i) propylene-derived monomer units;
(ii) from 5 wt. % to 25 wt. % comonomer units derived from any of C₂ or C₄-C₂₀ alpha olefins; and
(iii) from 0.1 wt. % to 10 wt. % graft comonomer units,
wherein, the grafted propylene-based elastomer has a heat of fusion of less than 75 J/g and an mm propylene triad tacticity of greater than 75%.

10. The composition of claim 9, wherein the grafted propylene-based elastomer comprises comonomers units derived from maleic anhydride.

11. The composition of claim 1, wherein the third component comprises a tackifier.

12. The composition of claim 11, wherein the tackifier comprises an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof.

13. The composition of claim 12, wherein the tackifier has a total dicyclopentadiene, cyclopentadiene, and methylcyclopentadiene derived content of from 60 wt. % to 100 wt. % of the total weight of the tackifier.

14. The composition of claim 12, wherein the tackifier has a weight average molecular weight of from 600 g/mole to 1400 g/mole.

15. The composition of claim 10, wherein the tackifier has an aromaticity of at least 5 wt. %.

16. The composition of claim 1 comprising from 60 wt. % to 80 wt. % of the filler.

17. The composition of claim 1, wherein the filler comprises at least one of titanium dioxide, calcium carbonate, barium sulfate, silica, carbon black, sand, glass beads, glass fibers, mineral aggregates, talc, and clay.

18. The composition of claim 16, wherein the filler comprises calcium carbonate and/or barium sulfate.

19. The composition of claim 1 comprising:
(i) from 10 wt. % to 20 wt. % of the first component comprising the propylene-based elastomer;
(ii) from 5 wt. % to 15 wt. % of the second component comprising a linear low density polyethylene;
(iii) from 60 wt. % to 80 wt. % of the filler; and
(iv) from 2 wt. % to 10 wt. % of a third component comprising a tackifier.

20. The composition of claim 1 having a Shore A hardness of less than 90.

21. The composition of claim 1 having an elongation at break of at least 180%.

22. A profile comprising the composition of claim 1.

23. A composite material comprising a first layer and a second layer bonded onto the first layer, wherein the first layer comprises the composition of claim 1.

24. A composite material, comprising a first layer and a second layer bonded onto the first layer,
wherein the first layer comprises, based on the weight of the first layer:
(i) from 10 wt. % to 20 wt. % of the propylene-based elastomer, the propylene-based elastomer comprising from 5 wt. % to 25 wt. %, at least one comonomer selected from ethylene and C₄-C₂₀ alpha-olefins and a propylene content of at least 75 wt. %, and having an mm propylene triad tacticity of at least an 75%, and a heat of fusion of less than 75 J/g;
(ii) from 5 wt. % to 15 wt. % of a liner low density polyethylene having a density of less than 0.940 g/cm³ and a melt index at 190° C./2.16 kg (I_{2.16}) of from 0.1 to 30 g/10 min;
(iii) from 60 wt. % to 80 wt. % of a filler; and
(iv) from 2 wt. % to 10 wt. % of a tackifier having a total dicyclopentadiene, cyclopentadiene, and methylcyclopentadiene derived content of from 60 wt. % to about 100 wt. % of the total weight of the tackifier, and has a weight average molecular weight of from 600 g/mole to 1400 g/mole,
wherein the second layer comprises polyurethane foam.

25. The composite material of claim 24, wherein the second layer is foamed and simultaneously bonded onto the first layer.
